(19) United States
(12) Patent Application Publication
(10) Pub. No.: US 2013/0300624 A1
(43) Pub. Date: Nov. 14, 2013

(54) BROADBAND END-FIRE MULTI-LAYER ANTENNA

(71) Applicant: Mohammad Fakharzadeh Jahromi, Toronto (CA)

(72) Inventor: Mohammad Fakharzadeh Jahromi, Toronto (CA)

(73) Assignee: Peraso Technologies Inc., Toronto (CA)

(21) Appl. No.: 13/466,584

(22) Filed: May 8, 2012

(51) Int. Cl. H01Q 9/16

(52) U.S. Cl. 343/793

(57) ABSTRACT

A microstrip antenna is formed on a multilayer substrate. The microstrip antenna includes a dipole formed of two dipole halves. Each of the dipole halves is formed in one of at least two layers of the multilayer substrate. Optionally, at least one passive reflector is located proximate the dipole in one of the layers, or a third layer of the substrate.

### FIELD OF THE INVENTION

The present invention relates generally to antennas, and more particularly to a micro-strip antenna formed on multiple layers of a substrate, providing broad frequency response.

### BACKGROUND OF THE INVENTION

Radio receivers/transmitters require one or more antennas. Modern electronic devices, such as portable computing devices including laptops, tablets and cellular telephones, wireless network base stations, wireless network interfaces, and the like, all require inclusion of one more such antennas. As these devices have become smaller, more versatile and more integrated, the size of these antennas has also needed to be reduced.

One common type of antenna is an end-fire mircostrip antenna—an example of which is a Yagi. End-fire microstrip antennas are often used in electronic devices such as cellular handsets, because they have a low profile, and can be mounted or formed on flat surfaces. Signals are radiated primarily at the end of antenna in three-space. Typically, a microstrip Yagi antenna is formed as a dipole of conductive material (usually metal) formed in a plane, mounted over a metal sheet acting as ground plane, and separated by a dielectric. The two metal sheets on either side of the dielectric together form a resonant piece of microstrip transmission line that acts as the antenna.

Yagi antennas are more particularly described in Pozar, David M. (2001). Microwave and RF Design of Wireless Systems. John Wiley & Sons Inc., the contents of which are hereby incorporated by reference.

Reducing antenna size while providing adequate gain, over a desired frequency range and reception/transmission angles remains a challenge, particularly in the presence of ever-increasing number of collocated electronic components and signals on the remainder of the electronic device on which the antenna is formed.

Accordingly, there remains a need for small antennas capable of being contained in small packages, and that provide a desired gain across a frequency range.

### SUMMARY OF THE INVENTION

In an example embodiment, a microstrip antenna is formed on a multilayer substrate. The microstrip antenna includes a dipole formed of two dipole halves. Each of the dipole halves is formed in one of at least two layers of the multilayer substrate. Optionally, at least one passive reflector is located proximate the dipole in one of the layers, or a third layer of the substrate.

In an embodiment, an antenna comprises, a substrate; two dipole halves, each formed on a different one of two vertically spaced layers in the substrate, the dipole halves defining a dipole; a feed extending from the two dipole halves, for coupling a signal to or from the two dipole halves.

In a further embodiment, a microstrip antenna is formed on a multilayer substrate, the microstrip antenna comprising a dipole and at least one passive reflector located proximate the dipole, wherein the dipole is formed in at least two layers of the multilayer substrate, and the at least one passive reflector is formed in a third layer of the substrate.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

In the figures which illustrate by way of example only, embodiments of the present invention,

FIG. 1 is a perspective view of a Yagi antenna, exemplary of an embodiment of the present invention;

FIG. 2A is a plan view of one layer (L1) of the Yagi antenna of FIG. 1;

FIG. 2B is a plan view of one layer (L1) of the Yagi antenna of FIG. 1;

FIG. 3 is a perspective view of a Yagi antenna including passive reflectors, exemplary of another embodiment of the present invention;

FIG. 4 is a simplified plan view of a Yagi antenna pair, exemplary of an embodiment of the present invention;

FIGS. 5A-5C are a plan views of layers L1, L2, and L3 of the Yagi antenna of FIG. 4;

FIG. 6 is a simplified plan view of another combined Yagi transmit/receive antenna pair, exemplary of an embodiment of the present invention;

FIG. 7 is a three-dimensional transmit radiation pattern an antenna in the font of the antenna of FIG. 1;

FIGS. 8-9 is a two-dimensional transmit radiation pattern an antenna in the form of the antenna of FIG. 1;

FIG. 10 is a two-dimensional transmit radiation pattern the antenna pair of FIG. 4; and

FIG. 11 is a graph depicting gain of the antenna of FIG. 1 for various frequencies.

### DETAILED. DESCRIPTION

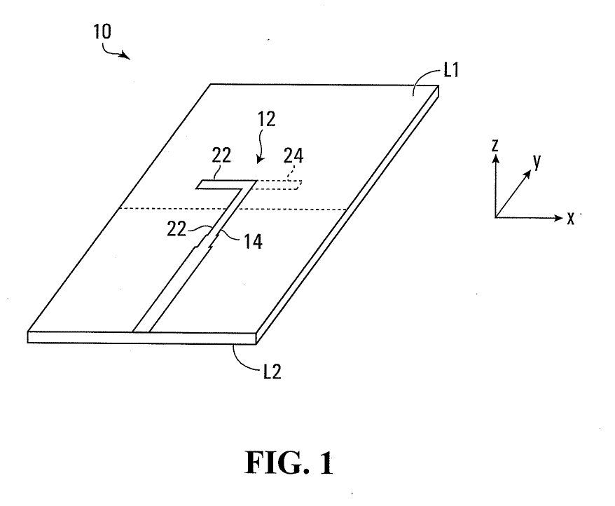

FIG. 1 is a schematic perspective view of a multi-layer end-fire antenna 10, exemplary of an embodiment of the present invention. As illustrated, antenna 10 includes a dipole 12, extending from feed 14, formed on a multi-layer substrate 20.

Dipole 12 and feed 14 are formed of conductive material, like copper or aluminium, on substrate 20 formed of an insulator. The characteristics of antenna 10—such as matching impedance, tuned frequency, bandwidth, etc.—are governed by the geometry of dipole 12, feed 14 and substrate 20 (e.g. length, width of dipole 12 and/or feed 14 and thickness of substrate 20), and their electrical characteristics (e.g. dielectric constant E of substrate 20).

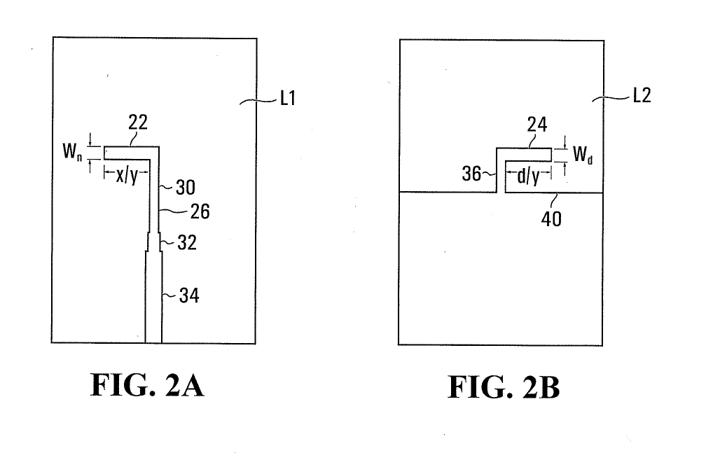

Conductive patterns of layers L1 and L2 are schematically depicted in plan view in FIGS. 2A and 2B. As best illustrated in FIG. 2A and 2B, dipole 12 is formed of two separate dipole halves 22 and 24 (sometimes referred to as monopoles). Each of the dipole halves 22, 24 is formed on a separate layer (L1, L2, respectively) of substrate 20. Each layer L1, L2 is vertically spaced (i.e. in the Z-direction) from the other layer L2, L1. L1 may, for example, be spaced from L2 by several 100 micro-meters, up to several millimetres.

A multi-layer substrate 20 may be formed using conventional multi-layer PCB formation techniques. For example, multilayer substrate 20 may be formed by impregnating each of several layers of dielectric material with adhesive. Each of these dielectric layers separates layers L1 and L2 of conductive plating. The multiple layers of substrate 20 may be aligned and bonded under heat and pressure.

Dipole half 22 extends from feed line 26 formed in layer L1, while dipole half 24 extends from feed line 36, in layer L2. Together feed lines 26 and 36 define feed 14. An optional rectangular ground-patch 40 (or ground-plane) is formed on layer L2, and feed line 36 extends therefrom, in overlapping relationship with feed line 26.

The width of dipole halves 22, 24 is W_{d}, while their length is approximately equal to λ/4, where λ is the wavelength of the tuned frequency of antenna 10. Dipole halves 22, 24 may be laterally spaced by the width of feed line 26/36.

Feed line 26 includes several tapered sections 30, 32 and 34. The first tapered section 30 has a width of about 200 μm (˜0.065λ), a length, l₁ of about 1.4 mm (˜0.45λ), and an impedance of 60Ω; section 32 has a width of about 225 μm (0.072λ), a length l₂ of 550 μm (˜0.18λ) and an impedance of 55Ω; section 34 has a width of 275 μm (˜0.09λ), and 55Ω.

The feed line sections 30, 32 and 34 of differing widths, allow feed line 26 to guide signal of a broader bandwidth than a single width feed line, allowing energy at frequencies outside the center frequency of dipole 12 to be coupled.

Feed line 36 extends from ground patch 40 in layer L2, and runs parallel to feed line 26, extending to dipole half 24, and co-extenisve with a portion of feed line 26. In the depicted embodiment, feed line 36 has a shape identical to feed line section 30, and a length equal to, or shorter than, feed line section 36. In alternate embodiments, ground patch 40 may occupy less of layer L2, and feed line 36 may be longer, and also co-extensive with feed line 26.

Conveniently, feed line 36 and the overlapping portion of feed line 26 form a wave guide in the Y-Z plane.

Multiple layers L1, L2 allow antenna 10 to be compact and allows for a 3D radiating structure. Moreover, conductive traces of layers L1, L2 may be arranged to take into account signals produced or routed to other components on any electronic device that includes antenna 10. The spacing between layers L1 and L2 may be determined based on other package constraints, as well as the desired characteristics of antenna 10.

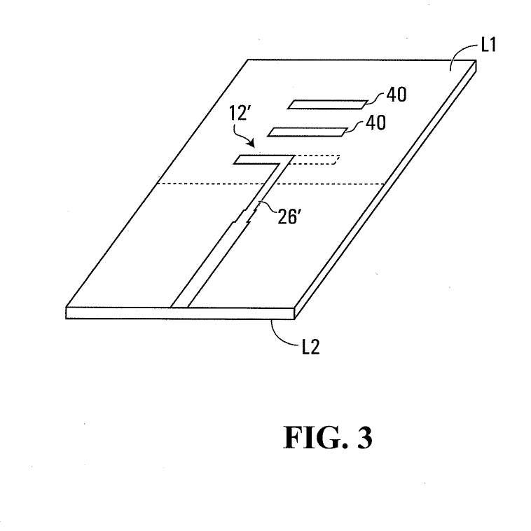

In an alternate embodiment, depicted in FIG. 3, an antenna assembly 10′ is formed like antenna 10, but includes one or more passive reflectors 40 located laterally adjacent to dipole 12′ that is formed of dipole portions 22′, 24′, formed on layer L1, or optionally in layer L2. Alternatively, passive reflectors 40 may be located in another layer L3, vertically spaced from layer L1 and L2. Layer L3 may be in front of layer L1, or between layers L1 and L2. Reflectors 40 have a width Wrᵢ, (e.g. 0.065λ) and extend parallel to dipole portions 24 in their respective plane(s), and may be spaced from each other and from dipole 12′ in the Z and. Reflectors 40 may have a length that is shorter than λ/2 (e.g. 0.4λ). Reflectors 40 may be of different lengths and widths. By forming reflectors in different layers, they may be laterally and vertically spaced from each other and dipole 12′ (i.e. in the Y and Z direction).

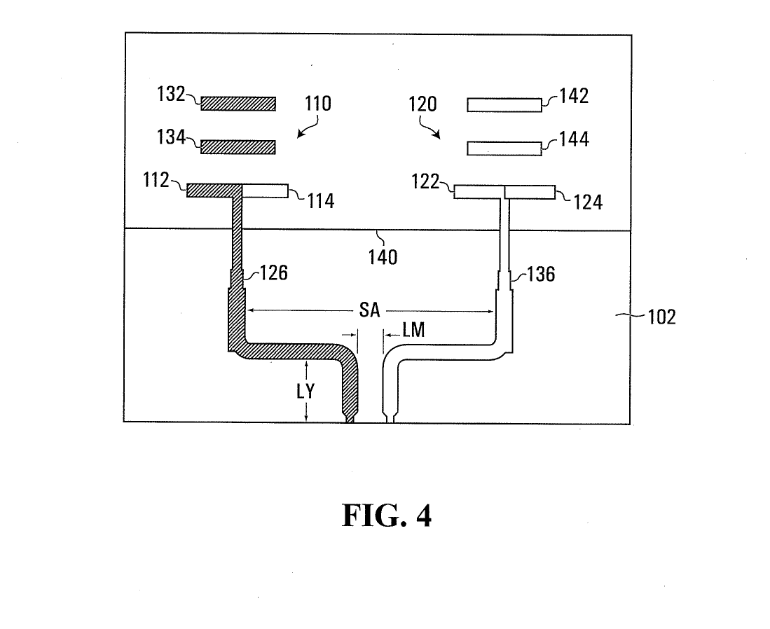

In yet another alternate embodiment, depicted in FIG. 4, an antenna assembly 100 is formed like antenna 10′, but includes two separate antennas 110 and 120 on a substrate 102. Each of antenna 110 and antenna 120 is a Yagi antenna, and respectively has two dipole halves 112, 114 and 122, 124. Dipole half 112 is formed on a first layer of L1 of substrate 102; dipole half 122 is formed in another plane L3 of substrate 102. The remaining dipole halves 114, 124 are formed on a layer L2. A ground patch (or ground plane) 140 is also formed on layer L2.

Reflectors 132 and 134 accompany antenna 110 and are formed on the same layer L1 of substrate 102. Reflectors 142 and 144 accompany antenna 120 and are formed on layer L3 of substrate 102. However, reflectors 132 and 134 could be formed on different layers of substrate, and on layers different from dipole section 112. Reflectors 142 and 144 could similarly be formed on different layers of substrate 102.

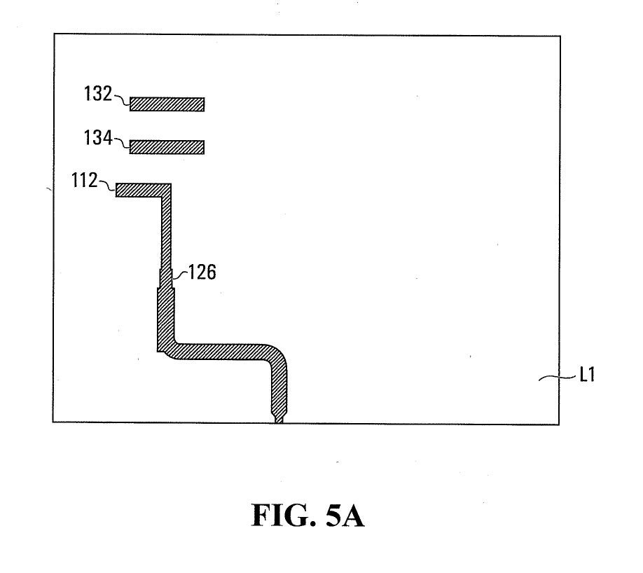

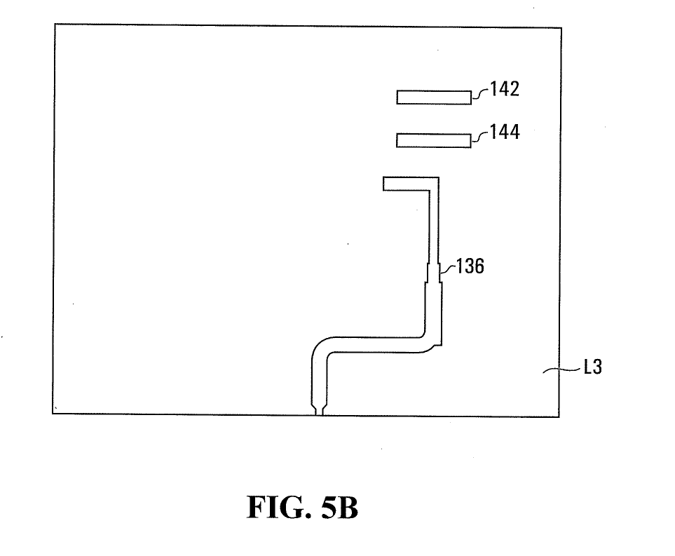

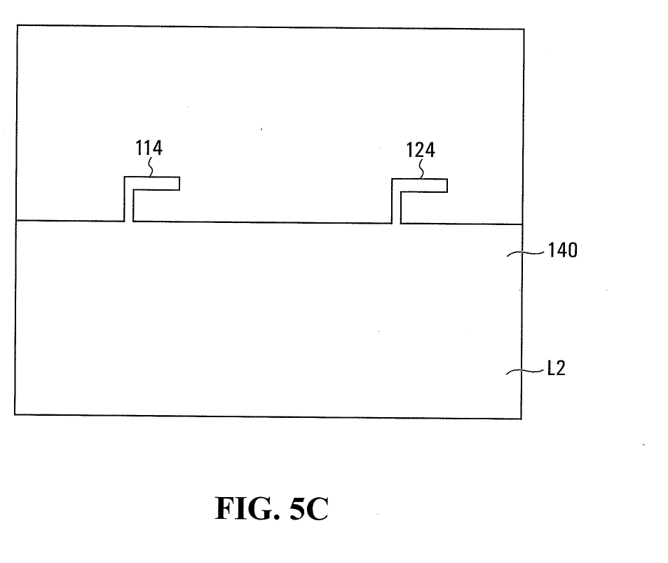

Feed lines 126 and 136, formed in layers L1 and L3 respectively provide a signal feed to dipole halves 112 and 122. Feed line 128 and 138 (FIGS. 5A and 5B) extend from ground patch 140 in layer L2 to dipole halves 114 and 124.

Feed lines 126 and 136, like feed line 26—FIGS. 1 and 2A, may have portions of differing widths to allow broader frequency signals to be coupled from/to antennas 110/120. The feed lines 126 and 136 may include a bend to position the antennas 110/120 away from other components.

Conveniently, the two antennas 110, 120 can be used independently as separate transmit or receive antennas, or combined with a power combiner to achieve a two-element array of Yagi antennas.

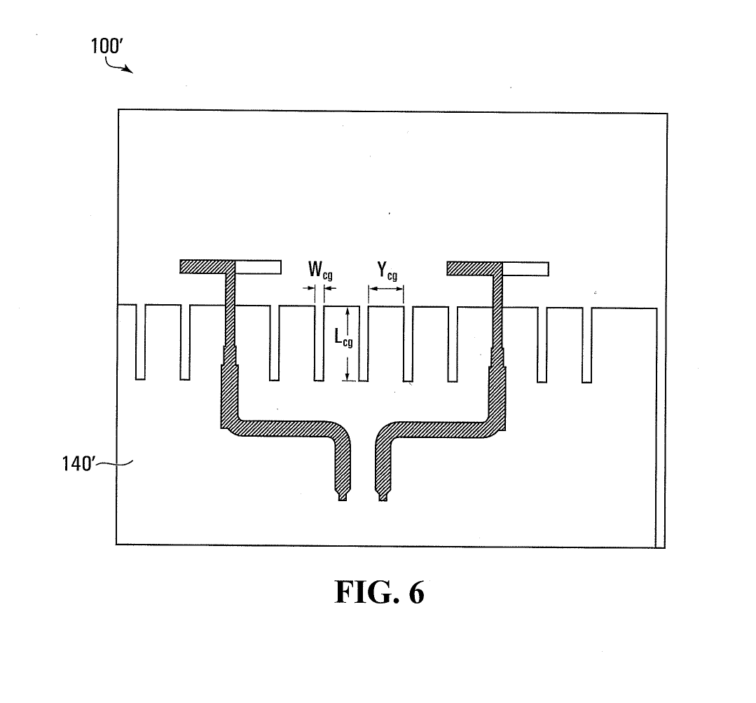

In a further alternate embodiment depicted in FIG. 6, a ground patch/plane 140′ in an antenna arrangement 100′ that is otherwise like antenna arrangement 100 of FIG. 4, and may include corrugations 150. Corrugations may be characterized by the spacing Y_{og}, of corrugations 150; their depth L_{og}; their width W_{og}. Corrugations 150 may improve antenna impedance matching and radiation. Modelling shows, for example, that corrugation may improve impedance matching for a Yagi antenna tuned to 57.5 GHz resulting in gain improvement by 25 dB.

Conveniently, passive portions (e.g. reflectors 142, 144,132, 134) may be distributed on other layers, and could also be included in antenna arrangement 100′. Conductive antenna portions (e.g. dipole halves, reflectors, etc.) on multiple layers of the substrate to contribute constructively to the radiating fields of the Yagi antenna. As well, the passive conductive portions (e.g. reflectors) may be spaced, laterally closer to each other, than comparable passive components/reflectors formed on the same layer.

Conveniently, parasitic elements of an example antenna (i.e. passive portions) in an electronic device package may be used for other purposes such as routing, power plane (capacitor), etc. The parasitic elements can be shaped to become directors for a dipole in other layers.

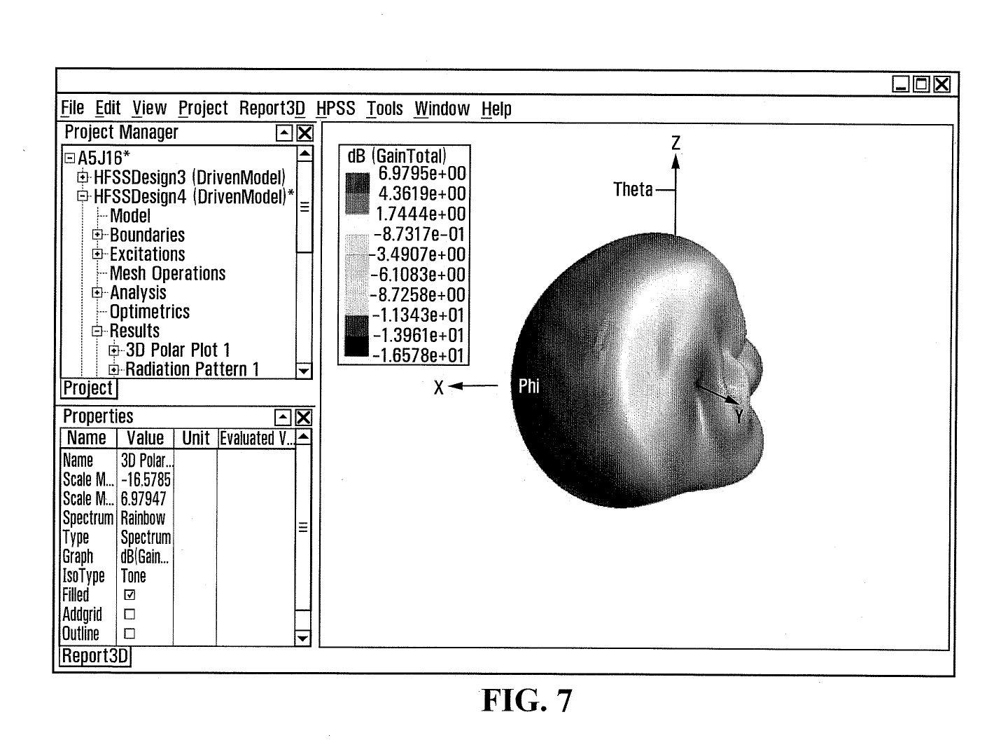

Now, the measured three-dimensional transmit radiation pattern of antenna 10 of FIG. 1 is depicted in FIG. 7.

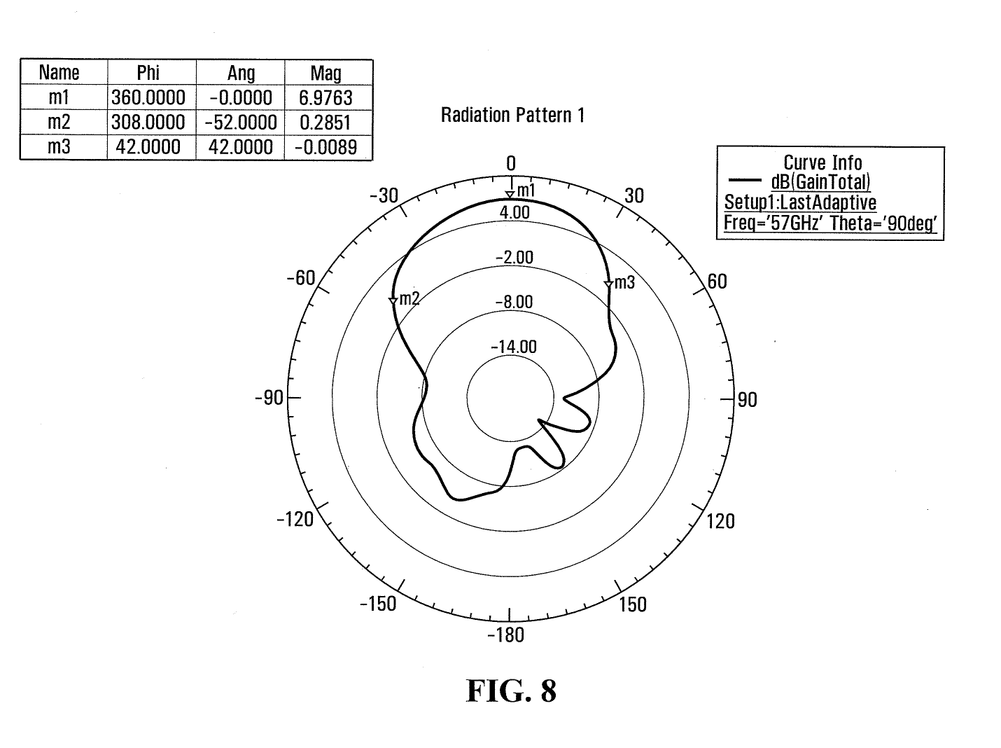

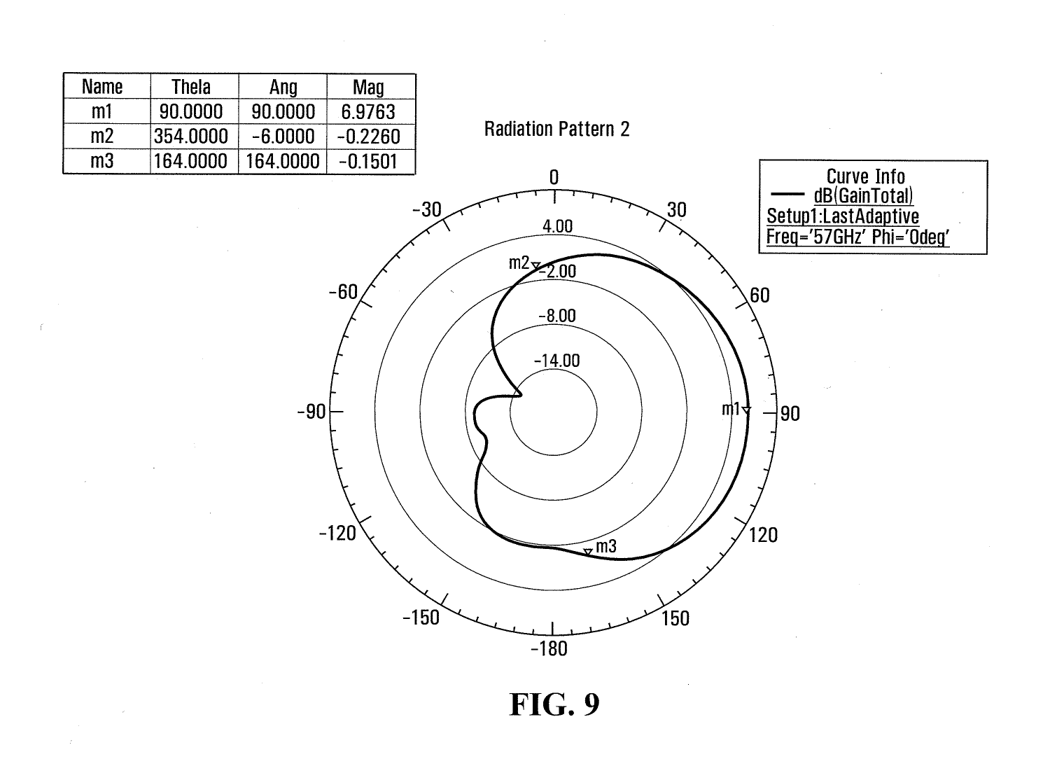

The measured two-dimensional transmit radiation pattern of antenna 10 is depicted in FIGS. 8 and 9.

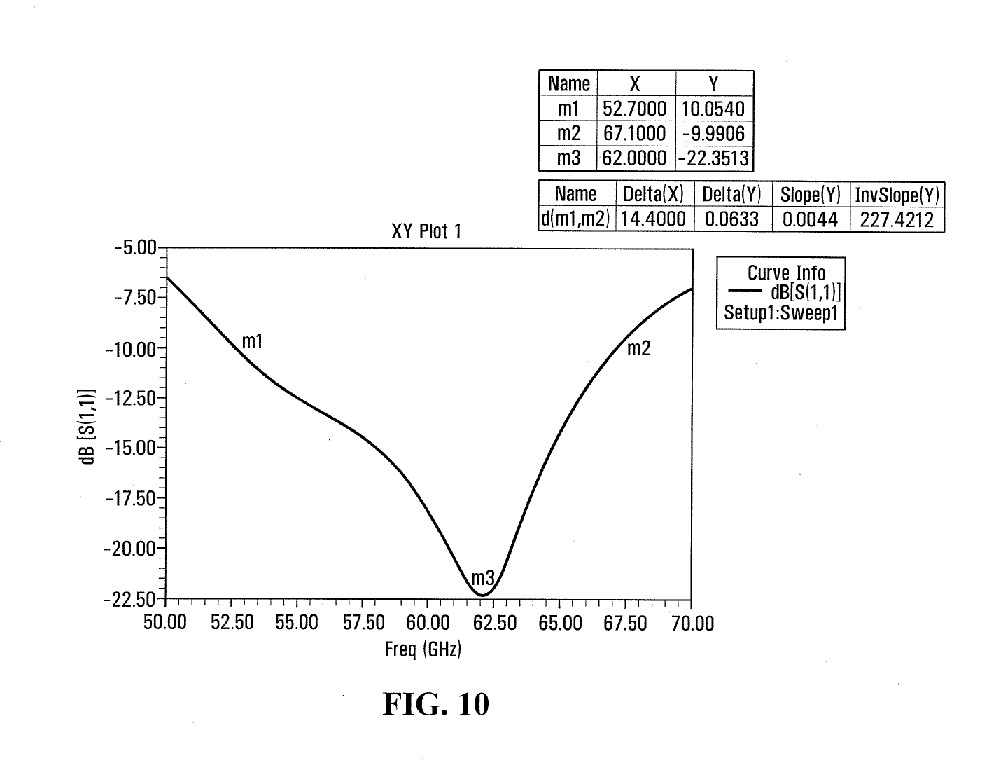

Similarly, a two-dimensional transmit radiation pattern of the antennas 110 and 120 of of FIG. 4, acting in concert, is depicted in FIG. 10. The combined signal of the two antennas acting in concert is increased by 3 dB.

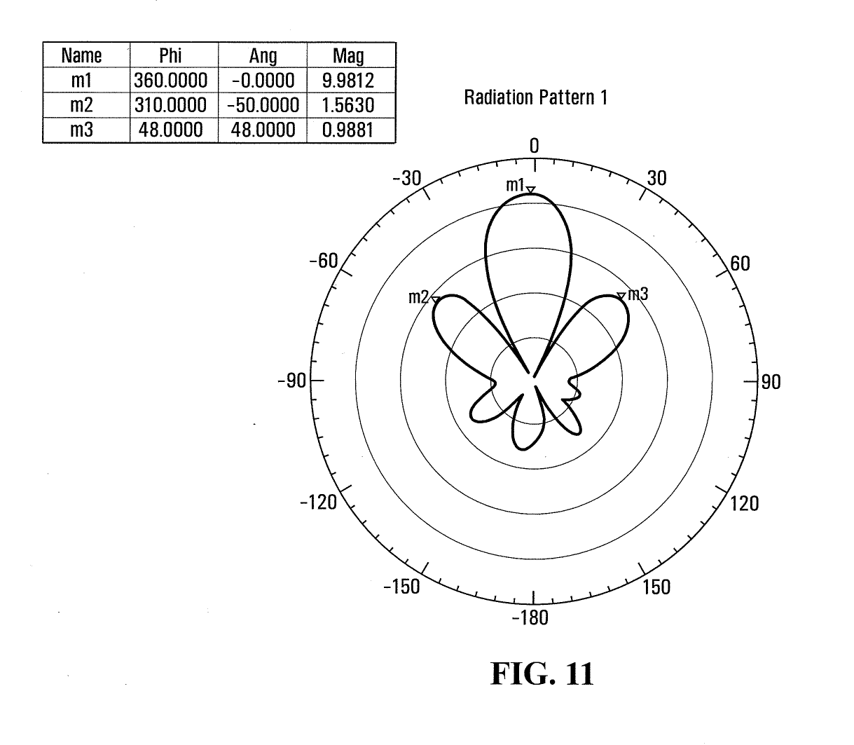

FIG. 11 depicts the resulting bandwidth of is a graph depicting gain of the antenna of FIG. 1 for various frequencies.

Of course, the above described embodiments are intended to be illustrative only and in no way limiting. The described embodiments of carrying out the invention are susceptible to many modifications of form, arrangement of parts, details and order of operation. The invention, rather, is intended to encompass all such modification within its scope, as defined by the claims.

What is claimed is:

1. An antenna comprising,
a substrate;
two dipole halves, each formed on a different one of two vertically spaced layers in said substrate, said dipole halves defining a dipole;
a feed extending from the two dipole halves, for coupling a signal to or from the two dipole halves.

2. The antenna of claim 1, wherein said feed comprises two feed lines, one formed on each one of said two layers.

3. The antenna of claim 2, further comprising a ground plane on one of said two layers.

4. The antenna of claim 2, wherein one of said feed lines extends from said ground plane.

5. The antenna of claim 4, wherein said ground patch is formed on a second of said two layers.

6. The antenna of claim 1, further wherein said ground plane is corrugated.

7. The antenna of claim 1, further comprising a generally rectangular reflector, extending next to said dipole.

8. The antenna of claim 1, wherein said generally rectangular reflector is formed on a first of said two layers.

9. The antenna of claim 8, wherein said generally rectangular reflector is the passive element in a further electronic circuit.

10. The antenna of claim 1, wherein said two layers are spaced by about

11. The antenna of claim 1, wherein said feed line has two or more portions of differing width.

12. The antenna of claim 1, wherein each dipole half has a length of λ/4, where λ is the wavelength of the tuned frequency of said antenna.

13. A microstrip antenna formed on a multilayer substrate, said microstrip antenna comprising a dipole and at least one passive reflector located proximate said dipole, wherein said dipole is formed in at least two layers of said multilayer substrate, and said at least one passive reflector is formed in a third layer of said substrate.
